(19) United States
(12) Patent Application Publication
(10) Pub. No.: US 2026/0143569 A1
(43) Pub. Date: May 21, 2026

(54) INDUCTION ENERGY TRANSMISSION SYSTEM

(71) Applicant: BSH Hausgeräte GmbH, Munich (DE)

(72) Inventors: Jesus Manuel Moya Nogues, Zaragoza (ES); Sergio Liorente Gil, Zaragoza (ES); Francisco Villuendas Lopez, Zaragoza (ES); Emilio Plumed Velilla, Zaragoza (ES); Jorge Tesa Betes, Zaragoza (ES); Jorge Pascual Aza, Zaragoza (ES)

(21) Appl. No.: 19/123,406

(22) PCT Filed: Nov. 21, 2023
(86) PCT No.: PCT/EP2023/082524

§ 371 Date: Apr. 23, 2025

(30) Foreign Application Priority Data
Nov. 28, 2022 (EP) 22383138.9

(51) Int. Cl. H05B 6/06; H05B 1/02; H05B 6/12

(52) U.S. Cl. CPC H05B 6/062; H05B 1/0266; H05B 6/1236; H05B 2213/06

(57) ABSTRACT

An induction energy transmission system includes a supply unit including a supply induction element to inductively provide energy. A control unit controls the supply unit using a control parameter of a control parameter set. A communications unit is designed for wireless communication between the control unit and the small household appliance. A small household appliance includes a receiving induction element to receive the inductively provided energy, a functional unit, and a small household appliance control unit to control the functional unit and to be supplied wirelessly with energy via the communications unit during a low-demand phase. The control unit is designed to control the supply unit with an altered control parameter set during the low-demand phase in order to inductively transmit a reduced amount of energy, relative to a power operation, to the receiving induction element in order to supply the small household appliance control unit with energy.

The invention relates to an induction energy transmission system according to the preamble of claim 1 and a method for operating an induction energy transmission system according to the preamble of claim 12.

Induction energy transmission systems for the inductive transmission of energy from a primary coil of a supply unit to a secondary coil of a small household appliance are already known from the prior art. For example, induction cooktops which are also provided for inductively supplying energy to small household appliances, in addition to an inductive heating of cooking utensils, are known. A standard which is currently still in development for inductively supplying energy to small household appliances, the so-called KI standard which is developed by the Wireless Power Consortium (WPC), provides that a small household appliance control unit of such small household appliances, which can be inductively supplied, has to be supplied with a minimum amount of energy even during low-demand phases, i.e. for example while the small household appliance is in a standby mode, in order to permit specific functions at all times for safety reasons. This minimum supply is intended to take place wirelessly according to the KI standard, and namely via NFC, and is also denoted as NFC harvesting. However, it is a drawback that an amount of energy which can be transmitted by means of conventional NFC communication elements is significantly limited, so that these conventional NFC communication elements have to be dimensioned correspondingly larger in order to be able to ensure a sufficient energy supply to the small household appliance control unit even during the low-demand phases. In addition, an efficiency of a wireless energy transmission via NFC has been hitherto very low, so that an energy efficiency is disadvantageously significantly reduced thereby.

The object of the invention, in particular but not limited thereto, is to provide a generic induction energy transmission system having improved properties regarding efficiency. The object is achieved according to the invention by the features of claims 1 and 12, while advantageous embodiments and developments of the invention can be found in the dependent claims.

The invention is based on an induction energy transmission system, in particular an induction cooking system, comprising a supply unit having at least one supply induction element for inductively providing energy, comprising a control unit for controlling the supply unit using at least one control parameter of a control parameter set, comprising at least one small household appliance having at least one receiving induction element for receiving the inductively provided energy, a functional unit and a small household appliance control unit for controlling the functional unit, and comprising a communications unit for wireless communication between the control unit and the small household appliance, wherein the small household appliance control unit can be supplied wirelessly with energy via the communications unit during a low-demand phase.

It is proposed that the control unit is provided for controlling the supply unit with at least one altered control parameter set during the low-demand phase in order to inductively transmit a reduced amount of energy, relative to a power operation, to the receiving induction element in order to supply the small household appliance control unit with energy.

Such an embodiment can advantageously provide an induction energy transmission system having improved properties regarding efficiency. In particular, an energy efficiency can be improved when the supply unit is controlled during the low-demand phase with at least one altered control parameter set in order to inductively transmit a reduced amount of energy, relative to a power operation, to the receiving induction element in order to supply the small household appliance control unit with energy, since an efficiency of an inductive energy transmission is between 50 percent and 90 percent, whereas an efficiency of a wireless energy transmission via NFC is only between 1 percent and 6 percent. In addition, an installation space efficiency can be advantageously improved since communication elements of the communications unit can be designed to be correspondingly smaller for the wireless energy transmission when the amount of energy required during the low-demand phase is transmitted only partially or not at all via the communications unit. As a result, a cost efficiency can be further advantageously improved since the existing supply unit can be used for the inductive energy transmission during the low-demand phase.

The induction energy transmission system has at least one main functionality in the form of a wireless energy transmission, in particular in supplying energy wirelessly to small household appliances. In one advantageous embodiment, the induction energy transmission system is configured as an induction cooking system having at least one further main function deviating from a pure cooking function, in particular at least one energy supply and an operation of small household appliances. For example, the induction energy transmission system could be configured as an induction oven system and/or as an induction grill system. In particular, the supply unit could be configured as part of an induction oven and/or as part of an induction grill. Preferably, the induction energy transmission system, which is configured as an induction cooking system, is configured as an induction cooktop system. The supply unit and the control unit are thus, in particular, part of an induction household appliance which is configured as an induction cooktop. However, the induction energy transmission system can alternatively also be configured as a kitchen energy supply system and can be additionally designed to provide cooking functions, in addition to a main function in the form of an energy supply and an operation of small household appliances. An induction household appliance of the induction energy transmission system preferably has a set-down plate for setting down the small household appliance. A “set-down plate” is intended to be understood to mean at least one, in particular plate-like, unit which is provided for setting down at least one small household appliance and/or one cooking utensil and/or for setting down at least one food to be cooked. The set-down plate could be configured, for example, as a countertop, in particular as a kitchen countertop, or as a partial region of at least one countertop, in particular at least one kitchen countertop, in particular of the induction energy transmission system. Alternatively or additionally, the set-down plate could be configured as a cooktop plate. The set-down plate which is configured as a cooktop plate could form, in particular, at least part of a cooktop external housing and could form the cooktop external housing at least to a large extent, in particular together with at least one external housing unit with which the set-down plate, which is configured as a cooktop plate, could be connected, in particular, in at least one installed state. Preferably, the set-down plate is manufactured from a non-metallic material. The set-down plate could be formed, for example, at least to a large extent from glass and/or from glass ceramic and/or from Neolith and/or from Dekton and/or from wood and/or from marble and/or from stone, in particular from natural stone, and/or from laminate and/or from plastics and/or from ceramic.

A “supply unit” is intended to be understood to mean a unit which inductively provides energy in at least one operating state and which has, in particular, a main functionality in the form of an energy provision. For providing energy, the supply unit has at least one supply induction element which has, in particular, at least one coil, in particular at least one primary coil, and/or is configured as a coil and which inductively provides energy, in particular in the operating state. The supply unit could have at least two, in particular at least three, advantageously at least four, particularly advantageously at least five, preferably at least eight and particularly preferably a plurality of, supply induction elements which in the operating state could in each case inductively provide energy and namely, in particular, to a single receiving induction element or to at least two or more receiving induction elements of at least one small household appliance and/or at least one further small household appliance. At least some of the supply induction elements could be arranged in close proximity to one another, for example in a row and/or in the form of a matrix. Preferably, the supply unit has at least one power unit. Preferably, the power unit carries out a frequency conversion in the operating state and, in particular, converts an input-side low frequency AC voltage into an output-side high frequency AC voltage. Preferably, the low frequency AC voltage has a frequency of at most 100 Hz. Preferably, the high frequency AC voltage has a frequency of at least 1000 Hz. The power unit is connected to the control unit and can be controlled by the control unit by means of control signals. Preferably, the power unit is provided to carry out the adjustment of the energy inductively provided by the at least one supply induction element by adjusting the high frequency AC voltage. Preferably, the power unit comprises at least one rectifier. Preferably, the power unit has at least one heating frequency element which is configured, in particular, as an inverter. Preferably, for operating the at least one supply induction element the heating frequency element generates an oscillating electrical current, preferably at a frequency of at least 15 kHz, in particular of at least 17 kHz and advantageously of at least 20 kHz. Preferably, the inverter comprises at least two bipolar transistors having an insulated gate electrode and particularly advantageously at least one damping capacitor.

A “control unit” is intended to be understood to mean an electronic unit which is provided to control and/or to regulate at least the supply unit. Preferably, the control unit comprises a computing unit and, in particular additionally to the computing unit, a storage unit with a control and/or regulating program which is stored therein and which is provided to be executed by the computing unit. In the power operation, the control unit controls the supply unit by means of the at least one control parameter of the control parameter set. A “control parameter set” is intended to be understood to mean a plurality of at least two control parameters which the control unit uses for controlling the supply unit and on the basis of which the control unit controls the energy inductively provided by the supply unit according to a demand of the small household appliance. The control parameter set can comprise, without being limited thereto, for example a switching frequency and/or a duty cycle of an inverter switching element of the power unit and/or an amount and/or an amplitude of an electrical current and/or an electrical voltage for operating at least one inverter switching element of the power unit as control parameters. The control unit is provided for controlling the supply unit during the low-demand phase with at least one altered control parameter set in order to inductively transmit a reduced amount of energy, relative to a power operation, to the receiving induction element in order to supply the small household appliance control unit with energy. The altered control parameter set comprises at least one altered control parameter which differs from a control parameter of the control parameter set which the control unit uses in the power operation. A “low-demand phase” is intended to be understood to mean a time period in which the small household appliance has a reduced energy demand. During the low-demand phase the small household appliance control unit is in operation and the functional unit is out of operation. The low-demand phase can comprise a configuration phase in which the small household appliance control unit communicates wirelessly with the control unit via the communications unit, for example in order to exchange operating parameters, such as for example a power demand for a power operation following the low-demand phase. It is also conceivable that the small household appliance is in a standby mode during the low-demand phase.

Preferably, the small household appliance is a location-independent household appliance which has at least the receiving induction element and at least one functional unit which in an operating state provides at least one household appliance function. “Location-independent” is intended to be understood to mean in this context that the small household appliance can be freely positioned by a user in a household, and in particular without aids, in particular in contrast to a large household appliance which is fixedly positioned and/or installed at a specific position in a household, such as for example an oven or a refrigerator. Preferably, the small household appliance is configured as a small kitchen appliance and in the operating state provides at least one household appliance function for processing food. The small household appliance could be configured, without being limited thereto, for example, as a multi-function food processor and/or as a blender and/or as a mixer and/or as a grinder and/or as kitchen scales or as a kettle or as a coffee machine or as a rice cooker or as a milk frother or as a deep fat fryer or as a toaster or as a juicer or as a slicing machine, or the like. The small household appliance comprises the functional unit which is designed to provide at least one small household appliance function, for example to provide a mixing function and/or a cooking function and/or a warming function and/or the like. The small household appliance also has the small household appliance control unit which is provided for controlling the functional unit. The functional unit is controlled via the small household appliance control unit during a power operation of the supply unit. The small household appliance control unit is also provided for communication with the control unit via the communications unit. The communication between the small household appliance control unit and the control unit can take place both during the power operation, for example for signaling a load change of the functional unit, and also during the low-demand phase, for example for exchanging operating parameters, for example a maximum power demand of the functional unit.

The receiving induction element of the small household appliance comprises at least one secondary coil and/or is configured as a secondary coil. In one operating state of the small household appliance, the receiving induction element supplies the functional unit with electrical energy.

The communications unit has at least one communication element which is connected to the control unit and is provided, in particular, for wirelessly receiving and sending data and additionally for wirelessly transmitting energy for supplying the small household appliance control unit. The communications unit also has at least one further communication element which is arranged inside the small household appliance and is provided, in particular, for wirelessly receiving and sending data and for wirelessly receiving the energy provided by the communication element. The communications unit could be provided for wireless data transmission and/or energy transmission via RFID or via WIFI or via Bluetooth or via ZigBee or for wireless data transmission and/or energy transmission according to a further suitable standard. Preferably, the communications unit is provided for a wireless data transmission and for a wireless energy transmission via NFC.

“Provided” is intended to be understood to mean specifically programed, designed and/or equipped. An object being provided for a specific function is intended to be understood to mean that the object fulfills and/or performs this specific function in at least one use state and/or operating state.

It is further proposed that the altered control parameter set comprises an altered switching frequency, relative to the power operation. A particularly accurate and reliable control of a value of the reduced amount of energy, which the supply unit inductively transmits to the receiving induction element for supplying the small household appliance control unit with energy during the low-demand phase, can be advantageously made possible. The altered switching frequency can be increased relative to a switching frequency in the power operation, in the event that the control unit operates the supply unit in a zero-voltage switching mode. Alternatively, the altered switching frequency can be reduced relative to the switching frequency in the power operation, in the event that the control unit operates the supply unit in a zero-current switching mode.

In addition, it is proposed that the altered control parameter set comprises an altered duty cycle, relative to the power operation. As a result, a flexibility when controlling the supply unit can be advantageously increased during the low-demand phase, by the duty cycle being able to be varied alternatively or additionally to the switching frequency. Preferably, in each case two inverter switching elements of the power unit are arranged in a half-bridge topology so that a maximum power is provided at a specific frequency with a duty cycle of 50 percent. Accordingly, the altered duty cycle can be increased or reduced relative to a duty cycle in the power operation, in order to provide the reduced amount of energy relative to the power operation.

Moreover, it is proposed that the small household appliance has an energy storage unit for storing the energy received during the low-demand phase. As a result, a flexibility and an efficiency can be advantageously increased, by an amount of energy which is not immediately required by the small household appliance control unit during the low-demand phase being able to be temporarily stored. An “energy storage unit” is intended to be understood to mean, in particular, a component which can receive, store and discharge energy, in particular chemical and/or preferably electrical energy. The energy storage unit could have, for example, at least one accumulator, for example a lithium-ion accumulator or the like. In a particularly advantageous embodiment, however, it is proposed that the energy storage unit comprises at least one capacitor. As a result, it is possible to improve further an efficiency, in particular a cost and/or installation space efficiency, of the small household appliance since an amount of energy received during the low-demand phase and to be stored by the energy storage unit is generally relatively small. The energy storage unit can also have a plurality of capacitors which can be arranged electrically in series and/or electrically in parallel with one another.

It is further proposed that a power provided via the supply unit during the low-demand phase is at least 5 W. As a result, it is advantageously possible to ensure a sufficient energy supply to the small household appliance control unit during the low-demand phase, in particular without an additional wireless energy supply via the communications unit. The power provided by the supply unit during the low-demand phase is, in particular, at least 6 W, advantageously at least 7 W, particularly advantageously at least 8 W, preferably at least 9 W and particularly preferably at least 10 W. In addition, it is proposed that a power provided via the supply unit during the low-demand phase is at most 20 W. As a result, an efficiency can be advantageously further improved. In particular, during the low-demand phase it is possible to prevent a power being provided by the supply unit which exceeds a demand of the small household appliance control unit during the low-demand phase. The power provided by the supply unit during the low-demand phase is, in particular, at most 19 W, advantageously at most 18 W, particularly advantageously at most 17 W, preferably at most 16 W and particularly preferably at most 15 W.

The control unit can be provided for permanently controlling the supply unit during the low-demand phase by means of the altered control parameter set. In an advantageous embodiment, however, it is proposed that the control unit is provided to control the supply unit during the low-demand phase periodically recurringly by means of the altered control parameter set. As a result, an efficiency can be advantageously further improved and a further possibility can be provided for controlling the amount of energy provided during the low-demand phase. The control unit can be provided, for example, for controlling the supply unit during the low-demand phase over a first control time period by means of the altered control parameter set, for subsequently interrupting a control of the supply unit during an idle period and then for controlling the supply unit over a second control time period again by means of the altered control parameter set. A duration of the idle period can be varied depending on the energy demand of the small household appliance control unit. The idle period lasts at least 20 ms, in particular at least 40 ms, advantageously at least 100 ms, particularly advantageously at least 250 ms, preferably at least 500 ms and particularly preferably at least 1 s.

It is further proposed that the small household appliance has a safety switching element which is provided to disconnect an electrical connection between the receiving induction element and the functional unit during the low-demand phase. As a result, a safety can be advantageously increased. In particular, the risk of an undesired start-up of the functional unit during the low-demand phase and a safety risk associated therewith can be minimized. The safety switching element can be configured, for example, as a relay. It is also conceivable that the safety switching element is configured as a semi-conductor switching element, for example as a transistor.

The invention further relates to a small household appliance of an induction energy transmission system according to one of the above-described embodiments. Such a small household appliance is characterized, in particular, by increased efficiency which can be achieved during an operation of the small household appliance control unit of the small household appliance within the low-demand phase.

The invention further relates to an induction household appliance, in particular an induction cooktop, of an induction energy transmission system according to one of the above-described embodiments, which has the supply unit and the control unit. Such an induction household appliance is characterized, in particular, by an increased efficiency which can be achieved when supplying energy to the small household appliance during the low-demand phase.

The invention is also based on a method for operating an induction energy transmission system, in particular an induction cooking system, in particular as claimed in one of the preceding claims, comprising a supply unit which has at least one supply induction element for inductively providing energy and which to this end is controlled by means of at least one control parameter of a control parameter set, comprising at least one small household appliance having at least one receiving induction element for receiving the inductively provided energy, at least one functional unit and a small household appliance control unit for controlling the functional unit and comprising a communications unit for wireless communication, wherein the small household appliance control unit can be supplied wirelessly with energy via the communications unit during a low-demand phase.

It is proposed that the supply unit is controlled by at least one altered control parameter set during the low-demand phase in order to inductively transmit a reduced amount of energy, relative to a power operation, to the receiving induction element in order to supply the small household appliance control unit with energy. Such an embodiment can advantageously provide a particularly efficient method for operating an induction energy transmission system.

The induction energy transmission system is not intended to be limited to the above-described use and embodiment. In particular, the induction energy transmission system can have a number of individual elements, components and units deviating from a number stated herein in order to fulfil a functionality described herein.

Further advantages are found in the following description of the drawing. Exemplary embodiments of the invention are shown in the drawing. The drawing, the description and the claims contain numerous features in combination. The person skilled in the art will expediently consider the features individually and combine them to form further meaningful combinations.

In the drawing

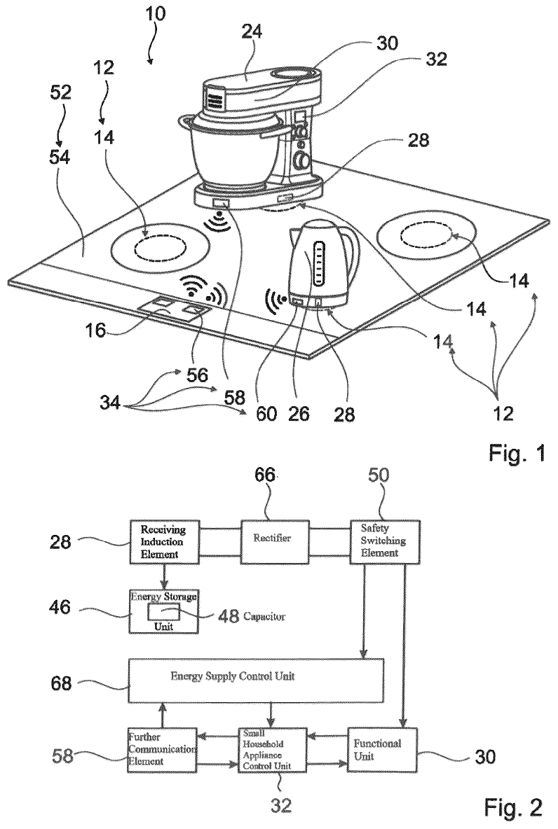

FIG. 1 shows an induction energy transmission system comprising an induction household appliance, a small household appliance and a further small household appliance in a schematic perspective view,

FIG. 2 shows a schematic diagram for illustrating a functionality of an energy supply of the small household appliance,

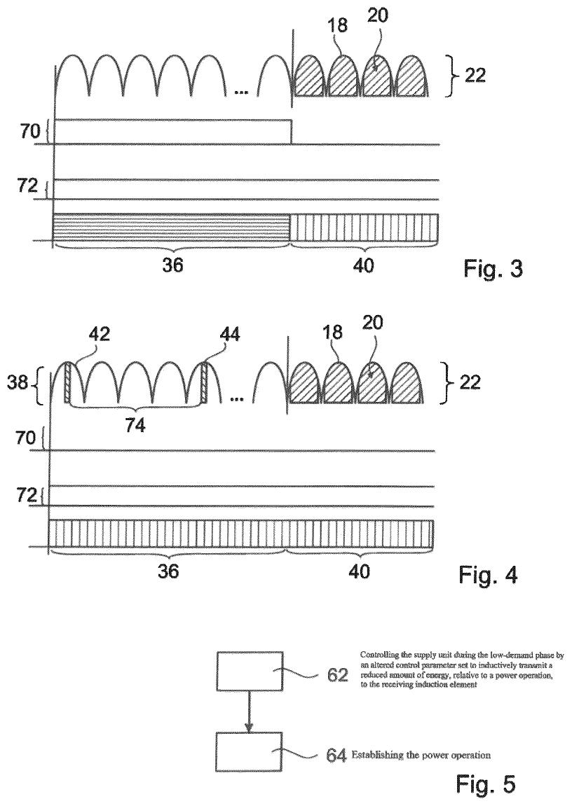

FIG. 3 shows a schematic diagram for illustrating a functionality of a wireless energy supply of the small household appliance via a communications unit of the induction energy transmission system during a low-demand phase,

FIG. 4 shows a schematic diagram for illustrating a functionality of an inductive energy supply of the small household appliance via a supply unit of the induction energy transmission system during the low-demand phase and

FIG. 5 shows a schematic process flow diagram for illustrating a method for operating the induction energy transmission system.

FIG. 1 shows an induction energy transmission system 10 in a schematic view. The induction energy transmission system 10 has a supply unit 12. The supply unit 12 has at least one supply induction element 14 for inductively providing energy. In the present case, the supply unit 12 has a total of four supply induction elements 14, wherein alternatively any other number of supply induction elements 14 might be conceivable.

The induction energy transmission system 10 has a control unit 16. The control unit 16 is provided for controlling the supply unit 12 by means of at least one control parameter 18 of a control parameter set 22.

The induction energy transmission system 10 comprises an induction household appliance 52. In the present case, the induction household appliance 52 is configured as an induction cooktop. The induction household appliance 52 has the supply unit 12 and the control unit 16.

The induction energy transmission system 10 has a set-down plate 54. The supply unit 12 is arranged below the set-down plate 54. In the present case, the set-down plate 54 is configured as a cooktop plate and is part of the induction household appliance 52 which is configured as an induction cooktop.

The induction energy transmission system 10 comprises a small household appliance 24. The small household appliance 24 has a receiving induction element 28 for receiving the inductively provided energy. In the present case, the small household appliance 24 is configured as a food processor. The small household appliance 24 has a functional unit 30 and a small household appliance control unit 32 for controlling the functional unit 30. In an operating state of the small household appliance 24, the functional unit 30 provides at least one small household appliance function, for example a warming function and/or a mixing function and/or the like.

In the present case, the induction energy transmission system 10 has a further small household appliance 26. The further small household appliance 26 also comprises a receiving induction element 28 for receiving the inductively provided energy. The further small household appliance 26 is configured as a kettle. The further small household appliance 26 also has a functional unit 30 and a small household appliance control unit 32 for controlling the functional unit 30. In an operating state of the further small household appliance 26, the functional unit 30 provides at least one small household appliance function, for example a function for boiling water.

The induction energy transmission system 10 also has a communications unit 34. The communications unit 34 is provided for a wireless communication between the control unit 16 and the small household appliance 24. In the present case, the communications unit 34 is also provided for a wireless communication between the control unit 16 and the further small household appliance 26. The communications unit 34 has a communication element 56 which is connected to the control unit 16 and which is provided for wirelessly sending and receiving data. The communications unit 34 has a further communication element 58 which is arranged in the small household appliance 24 and which is provided for wirelessly sending and receiving data. The communications unit 34 also has a further communication element 60 which is arranged in the further small household appliance 26 and which is provided for wirelessly sending and receiving data. In the present case, the communications unit 34 is configured as an NFC communications unit and is provided for a wireless communication via NFC between the control unit 16 and the small household appliance 24 and/or the further small household appliance 26.

The small household appliance control unit 32 of the small household appliance 24 is able to be supplied wirelessly with energy via the communications unit 34 during a low-demand phase 36 (see FIG. 3). Equally the small household appliance control unit 32 of the further small household appliance 26 is also able to be supplied wirelessly with energy via the communications unit 34 during a low-demand phase 36. The wireless energy supply of the small household appliance control unit 32 via the communications unit 34 during the low-demand phase 36 is also known to the person skilled in the art by the term NFC harvesting.

The functionality of the induction energy transmission system 10 is described hereinafter on the basis of the small household appliance 24, wherein the following description can be transferred analogously to the further small household appliance 26.

In the present case, the control unit 16 is provided for controlling the supply unit 12 during the low-demand phase 36 with at least one altered control parameter set 38 in order to transmit inductively a reduced amount of energy, relative to a power operation 40, (see FIGS. 3 and 4) to the receiving induction element 28 in order to supply the small household appliance control unit 32 with energy. The small household appliance control unit 32 can thus also be inductively supplied with a reduced amount of energy, relative to the power operation 40, alternatively or additionally to a wireless energy supply via the communications unit 34 during the low-demand phase 36.

FIG. 2 shows a schematic diagram for illustrating a functionality of the small household appliance 24.

The small household appliance 24 has an energy storage unit 46 for storing the energy received during the low-demand phase 36. The energy storage unit 46 comprises at least one capacitor 48 for storing the energy received during the low-demand phase 36. In the low-demand phase 36, the capacitor 48 of the energy storage unit 46 is connected to the receiving induction element 28 and stores the energy inductively received by the receiving induction element 28.

In the present case, the small household appliance 24 has a rectifier 66. The rectifier 66 is connected to the receiving induction element 28 and is provided to rectify an AC current induced in the receiving induction element 28. Depending on the type of functional unit 30, however, the small household appliance 24 could also be configured without a rectifier 66 and the functional unit 30 could be directly supplied in the power operation 40 (see FIG. 3) with the AC current induced in the receiving induction element 28.

The small household appliance 24 has a safety switching element 50. The safety switching element 50 is provided to disconnect an electrical connection between the receiving induction element 28 and the functional unit 30 during the low-demand phase 36.

The small household appliance 24 has an energy supply control unit 68. The energy supply control unit 68 is provided to control an energy supply to the small household appliance control unit 32 during the low-demand phase 36. Via the safety switching element 50 the energy supply control unit 68 can connect the small household appliance control unit 32 during the low-demand phase 36 to the receiving induction element 28 for supplying energy.

In FIG. 2 the further communication element 58 of the communications unit 34 is also shown, the small household appliance control unit 32 being able to be supplied thereby wirelessly with energy in the low-demand phase 36. The communication element 58 is also connected to the energy supply control unit 68 and can forward energy received wirelessly from the communication element 56 during the low-demand phase 36 via the energy supply control unit 68 to the small household appliance control unit 32.

During the low-demand phase 36, a connection between the functional unit 30 and the receiving induction element 28 is disconnected by the safety switching element 50. During the power operation 40, a connection between the receiving induction element 28 and the functional unit 30 is produced via the safety switching element 50 and the functional unit 30 can be supplied with energy and controlled via the small household appliance control unit 32.

FIG. 3 shows a schematic diagram for illustrating a functionality of the wireless energy supply of the small household appliance control unit 32 via the communications unit 34 during the low-demand phase 36.

An operating state 70 of the communications unit 34 is shown in the diagram. If the communications unit 34 is active, the small household appliance control unit 32 can be supplied during the low-demand phase 36 with energy which is transmitted wirelessly from the communication element 56 to the further communication element 58.

An operating state 72 of the small household appliance control unit 32 is also shown in the diagram. The small household appliance control unit 32 is active both during the low-demand phase 36 and during the power operation 40. During the low-demand phase 36 the small household appliance control unit 32 communicates wirelessly with the control unit 16 via the communications unit 34, for example for configuration purposes. For example, during the low-demand phase 36 the small household appliance control unit 32 can signal a power demand for a subsequent power operation 40.

The control unit 16 controls the supply unit 12 during the power operation 40 by means of the at least one control parameter 18 of the control parameter set 22. The control parameter 18 can be, for example, a switching frequency of an inverter (not shown) of the supply unit 12 by which the control unit operates one or more of the supply induction elements 14 during the power operation 40. The control parameter set 22 also comprises a further control parameter 20. The further control parameter 20 can be, for example, a duty cycle with which the control unit 16 operates the inverter during the power operation 40.

FIG. 4 shows a schematic diagram for illustrating a functionality of the wireless inductive energy supply of the small household appliance 24 via the supply unit 12 during the low-demand phase 36. During the low-demand phase 36, the small household appliance control unit 32 can be inductively supplied with the reduced amount of energy, relative to the power operation 40. To this end, the control unit 16 controls the supply unit 12 with the altered control parameter set 38 in order to transmit inductively the reduced amount of energy, relative to the power operation 40, to the receiving induction element 28 of the small household appliance 24 from one or more of the supply induction elements 14.

The altered control parameter set 38 comprises an altered switching frequency 42, relative to the power operation 40. For example, the altered switching frequency 42 can be a switching frequency which is increased relative to the switching frequency used in power operation 40 as a control parameter 18 if the control unit 16 operates the inverter in a zero-voltage switching mode.

In the present case, the altered control parameter set 38 also comprises an altered duty cycle 44, relative to the power operation 40. For example, during the low-demand phase 36 the control unit 16 can use as a further control parameter 20 an altered duty cycle 44 which is increased or reduced relative to the duty cycle used in the power operation 40, wherein it should be mentioned that the inverter of the supply unit 12 has a half-bridge topology and provides a maximum power with a duty cycle of 50 percent and a specific switching frequency.

During the low-demand phase 36, the power provided via the supply unit 12 is at least 5 W. In the present case, the power provided via the supply unit 12 during the low-demand phase 36 is at least 10 W. The power provided via the supply unit 12 during the low-demand phase 36 is at most 20 W. In the present case, the power provided via the supply unit 12 during the low-demand phase 36 is at most 15 W. The control unit 16 controls the minimum and maximum power provided via the supply unit 12 during the low-demand phase 36 by varying the altered switching frequency 42 and/or the altered duty cycle 44 of the altered control parameter set 38.

The control unit 16 is also provided to control the supply unit 12 during the low-demand phase 36 periodically recurringly by means of the altered control parameter set 38. For example, the control unit 16 can control the supply unit 12 during the low-demand phase 36 with the altered control parameter set 38 and then not operate the supply unit during an idle period 74. Following the idle period 74, the control unit 16 can control the supply unit 12 again during the low-demand phase 36 with the altered control parameter set 38. A duration of the idle period 74 can vary depending on the energy demand of the small household appliance control unit 32 during the low-demand phase 36 and last, for example, one or more seconds. It is also conceivable, however, that the control unit 16 permanently controls the supply unit 12 during the low-demand phase 36 with the altered control parameter set 38, wherein excess energy, which is not directly required by the small household appliance control unit 32, can be stored in the energy storage unit 46.

FIG. 5 shows a schematic process flow diagram of a method for operating the induction energy transmission system 10. The method comprises at least two method steps 62, 64. In a first method step 62 of the method, the supply unit 12 is controlled during the low-demand phase 36 by at least one altered control parameter set 38 in order to inductively transmit a reduced amount of energy, relative to a power operation 40, to the receiving induction element 28 in order to supply the small household appliance control unit 32 with energy. In a subsequent second method step 64 of the method, the power operation 40 takes place, wherein the supply unit 12 is controlled by means of the at least one control parameter 18, 20 of the control parameter set 22 and inductively provides, via the supply induction element 14, a greater amount of energy which is received from the receiving induction element 28 and with which the functional unit 30 and the small household appliance control unit 32 are supplied.

### REFERENCE SIGNS

10 Induction energy transmission system
12 Supply unit
14 Supply induction element
16 Control unit
18 Control parameter
20 Further control parameter
22 Control parameter set
24 Small household appliance
26 Further small household appliance
28 Receiving induction element
30 Functional unit
32 Small household appliance control unit
34 Communications unit
36 Low-demand phase
38 Altered control parameter set
40 Power operation
42 Altered switching frequency
44 Altered duty cycle
46 Energy storage unit
48 Capacitor
50 Safety switching element
52 Induction household appliance
54 Set-down plate
56 Communication element
58 Further communication element
60 Further communication element
62 First method step
64 Second method step
66 Rectifier
68 Energy supply control unit
70 Operating state
72 Operating state
74 Idle period

1-12. (canceled)

13. An induction energy transmission system, comprising:
a supply unit comprising a supply induction element designed to inductively provide energy;
a control unit designed to control the supply unit using a control parameter of a control parameter set;
a communications unit designed for wireless communication between the control unit and the small household appliance; and
a small household appliance comprising a receiving induction element designed to receive the inductively provided energy, a functional unit, and a small household appliance control unit designed to control the functional unit and to be supplied wirelessly with energy via the communications unit during a low-demand phase;
wherein the control unit is designed to control the supply unit with an altered control parameter set during the low-demand phase in order to inductively transmit a reduced amount of energy, relative to a power operation, to the receiving induction element in order to supply the small household appliance control unit with energy.

14. The induction energy transmission system of claim 13, constructed in a form of an induction cooking system.

15. The induction energy transmission system of claim 13, wherein the altered control parameter set comprises an altered switching frequency, relative to the power operation.

16. The induction energy transmission system of claim 13, wherein the altered control parameter set comprises an altered duty cycle, relative to the power operation.

17. The induction energy transmission system of claim 13, wherein the small household appliance comprises an energy storage unit designed to store the energy received during the low-demand phase.

18. The induction energy transmission system of claim 17, wherein the energy storage unit comprises a capacitor.

19. The induction energy transmission system of claim 13, wherein the supply unit is designed to provide a power of at least 5 W during the low-demand phase.

20. The induction energy transmission system of claim 13, wherein the supply unit is designed to provide a power of at most 20 W during the low-demand phase.

21. The induction energy transmission system of claim 13, wherein the control unit is designed to control the supply unit during the low-demand phase periodically recurringly using the altered control parameter set.

22. The induction energy transmission system of claim 13, wherein the small household appliance comprises a safety switching element designed to disconnect an electrical connection between the receiving induction element and the functional unit during the low-demand phase.

23. A small household appliance of an induction energy transmission system as set forth in claim 13, the small household appliance comprising:
a receiving induction element designed to receive an inductively provided energy from a supply unit of the induction energy transmission system, said receiving induction element receiving a reduced amount of energy, relative to a power operation, during a low-demand phase;
a functional unit; and
a small household appliance control unit designed to control the functional unit and to be supplied wirelessly with energy via a communications unit of the induction energy transmission system during the low-demand phase.

24. The small household appliance of claim 23, further comprising an energy storage unit designed to store the energy received during the low-demand phase.

25. The small household appliance of claim 24, wherein the energy storage unit comprises a capacitor.

26. The small household appliance of claim 23, further comprising a safety switching element designed to disconnect an electrical connection between the receiving induction element and the functional unit during the low-demand phase.

27. An induction household appliance of an induction energy transmission system as set forth in claim 13, the induction household appliance comprising:
a supply unit comprising a supply induction element designed to inductively provide energy; and
a control unit designed to control the supply unit using a control parameter of a control parameter set and to control the supply unit with an altered control parameter set during a low-demand phase in order to inductively transmit a reduced amount of energy, relative to a power operation.

28. The induction household appliance of claim 27, constructed in a form of an induction cooktop.

29. The induction household appliance of claim 27, wherein the supply unit is designed to provide a power of at least 5 W during the low-demand phase.

30. The induction household appliance of claim 27, wherein the supply unit is designed to provide a power of at most 20 W during the low-demand phase.

31. The induction household appliance of claim 27, wherein the control unit is designed to control the supply unit during the low-demand phase periodically recurringly using the altered control parameter set.

32. A method for operating an induction energy transmission system, the method comprising:
controlling a supply induction element of a supply unit to inductively provide energy using a control parameter of a control parameter set;
transmitting the inductively provided energy to a receiving induction element of a small household appliance; and
controlling the supply unit with an altered control parameter set during a low-demand phase at which a reduced amount of energy, relative to a power operation, is inductively transmitted to the receiving induction element in order to supply a small household appliance control unit of the small household appliance with energy.
